(19) United States
(12) Patent Application Publication
(10) Pub. No.: US 2013/0295291 A1
(43) Pub. Date: Nov. 7, 2013

(54) Low Humidity Cure for Moisture Curable Coatings

(71) Applicant: Stephen John Crowley, Tomball, TX (US)

(72) Inventor: Stephen John Crowley, Tomball, TX (US)

(21) Appl. No.: 13/976,096

(22) PCT Filed: Dec. 23, 2011
(86) PCT No.: PCT/EP11/73938

§ 371 Date: Jun. 26, 2013

Related U.S. Application Data
(60) Provisional application No. 61/428,346, filed on Dec. 30, 2010.

(51) Int. Cl. C09D 7/12

(52) U.S. Cl. CPC C09D 7/1233
USPC 427/387; 427/397.7; 427/385.5; 106/287.16; 524/173

(57) ABSTRACT

The invention is directed to a low humidity cure moisture curable coating composition which includes a moisture cure binder component that includes: a moisture curable binder material and at least one organic solvent; and a humectant component that includes a slow evaporating volatile humectant; wherein the humectant is present in an amount sufficient to increase the cure rate of the coating and to provide a cured coating having acceptable mechanical and cosmetic properties at a relative humidity of 50% or lower; and the invention is also directed to a method for curing moisture curable coating compositions under low humidity conditions.

### FIELD OF THE INVENTION

The field of the invention relates to moisture curable protective coatings, and in one aspect to zinc containing alkyl silicate (zinc silicate) coatings. More particularly, it refers to coating and curing of moisture curable, e.g., zinc silicate, coatings under relatively low humidity conditions.

### BACKGROUND OF THE INVENTION

Moisture curable coatings are used for various applications to provide protection to substrates. For example, zinc coating compositions with a silicate binder have been used for the protection of steel surfaces against rust. Zinc compositions have also been used in ceramic coatings which are useful as high-temperature coating systems. Such zinc compositions are typically in the form of solvent-borne zinc silicate coatings that can be used, for example, as a primer coating for metals.

Solvent-borne zinc silicate coatings typically develop good resistance to rain within thirty minutes of application and good protection against metal corrosion. However, such zinc silicate coatings can form soft, friable coatings or be prone to delamination when cured under conditions of low humidity. It has been reported that such coatings cured at 40% relative humidity (or less) and 25° C. is unlikely to achieve satisfactory cure and can remain soft and friable even after prolonged cure. Other coatings that have moisture curable chemistry also have problems with or are incapable of curing under low humidity conditions.

In order to avoid such curing problems it is common practice in the coating industry to spray some moisture coatings, e.g., zinc silicate coatings, with water if the humidity at the time of application is low or, for chemistries where pre-applying water cannot be done, waiting until humidity conditions are acceptable to properly cure the coating.

Accordingly, there exists a need to achieve satisfactory curing of moisture cure coatings, e.g., solvent-borne zinc silicate coatings, under low relative humidity conditions, while avoiding the problems discussed above.

### SUMMARY OF THE INVENTION

It has been found that a low humidity moisture cure coating, e.g., a low humidity cure zinc silicate coating, can be achieved, while avoiding the above mentioned problems, by including certain slow evaporating volatile humectants (or hygroscopic materials) in the coating system. The humectant is present in an amount sufficient to increase the cure rate of the coating and to provide acceptable mechanical and cosmetic properties for the cured coating under low humidity conditions. In one embodiment, the slow evaporating volatile humectant is chosen from dimethyl sulfoxide (DMSO), mono ethers of diethylene glycol, propylene carbonate and mixtures thereof. In a preferred embodiment, the slow evaporating volatile humectant is DMSO.

In one aspect, the invention is directed to a moisture curable coating composition having a moisture cure binder component that comprises a moisture curable binder material and at least one organic solvent; and a humectant component that comprises a slow evaporating volatile humectant; wherein the humectant is present in an amount sufficient to increase the cure rate of the coating and to provide a cured coating having acceptable mechanical and cosmetic properties at a relative humidity of 50% or lower. In embodiments of the invention, the humectant is present in an amount sufficient to increase the cure rate of the coating and to provide a cured coating having acceptable mechanical and cosmetic properties at a relative humidity of 40% or lower, or 30% or lower, or 20% or lower, or 10% or lower.

In one embodiment, the binder material is not formed in the presence of the humectant, i.e., the reaction medium that forms the moisture curable binder used in the coating does not include the humectant. In such a case, the humectant and the moisture curable binder material are each separately added to the coating composition. In embodiments of the invention, the binder component is substantially free of, or free of, the humectant. In such embodiments, the humectant can be combined with the binder component after the binder component is prepared. In one embodiment, the humectant can be combined with the binder component just prior to using the coating, e.g., in a multi-part coating system that is combined and mixed on site where the coating will be applied. In embodiments of the invention, the moisture curable coating composition contains about 2 wt % or less, or 1 wt % or less, or is substantially free of, or is free of, colloidal silica.

In one embodiment, the moisture curable binder material is chosen from an alkyl silicate based material, a hybrid organic alkoxysilane based material, a polyisocyanate based material which yields polyurea via moisture curing, a polyketamine based material which yields free amines via moisture curing for reaction with epoxies or isocyanates, and polyurethane compositions of isocyanate and polyol where the isocyanate is in sufficient excess to the polyol that moisture cure of isocyanate (yielding polyurea) is required to properly cure the coating. In one embodiment, the moisture curable binder material is an alkylsilicate based material. In embodiments of the invention, depending on the type of moisture curable binder material, the coating composition can be a protective coating of a type chosen from a primer or a topcoat.

In one embodiment, the invention is directed to a two part zinc silicate coating composition, comprising a first alkyl silicate component (part A) and a second zinc component (part B). Part A comprises an alkyl silicate hydrolysate intermediate, a glycol ether or alcohol solvent, and a humectant, wherein the hydrolysate intermediate is the reaction product of an alkyl silicate and at least one water miscible alcohol functional solvent, and wherein the glycol ether or alcohol solvent is a type and is present in an amount that increases the cure rate of the intermediate. In one embodiment, the hydrolysate intermediate is formed in the absence of the humectant and the humectant is added as the last component of part A. The humectant can be chosen from the humectants described above. In embodiments of the invention, Part A contains about 2 wt % of less, or 1 wt % of less, or is substantially free of, or is free of, colloidal silica. In one embodiment, the glycol ether or alcohol solvent is a propylene glycol ether. Part B comprises metallic zinc powder or dust.

In an embodiment of the invention, the humectant is added to part A of a fast cure alkyl silicate composition, such as Interzinc 22, QHA285, sold by International Paint. The Interzinc 22 part A with humectant can then be mixed with the zinc component, part B, such as Interzinc 22, QHA027, sold by International Paint, to form the low humidity cure zinc silicate coating composition.

The humectant, e.g., DMSO, can be added in an amount in the range of about 1 to about 8 wt %, or about 2 to about 7 wt %, or about 3 to about 6 wt %, or about 4 to about 5 wt %, based on binder component (part A) with the DMSO included.

In one embodiment, the zinc silicate coating composition is in the form of a three part system, where the humectant is added via a humectant composition (part C). In one embodiment, the humectant composition contains one or more organic solvents or water. In such a three part system, where the humectant is DMSO, part C will generally contain water or a solvent to decrease the freezing point of the DMSO. In such an embodiment, where water is combined with DMSO to reduce the freezing point of the humectant (e.g., DMSO) composition, the amount of water present in the range of about 10 to about 18 wt %, or about 14 to about 18 wt %, based on the humectant composition (part C).

In another aspect, the invention is directed to a process for curing moisture curable coating compositions under low humidity conditions. In one embodiment, the process comprises: providing a high humidity moisture curable coating composition that is capable of curing under sufficiently high relative humidity, but which fails to form a cured coating having acceptable mechanical and cosmetic properties at a relative humidity of 50 wt % or lower; adding a slow evaporating volatile humectant to the high humidity moisture curable coating, in an amount sufficient to increase the cure rate of the coating at a relative humidity of 50% or lower and sufficient to provide a cured coating having acceptable mechanical and cosmetic properties when cured under such conditions; mixing the resulting composition containing the humectant, to provide a low humidity cure coating composition; coating the low humidity cure coating composition on a substrate; and curing the coating on the substrate under conditions where the relative humidity is 50% or lower. The moisture curable coating composition can be a type chosen from the types of moisture curable coating compositions described above.

In embodiments of the invention, the high humidity moisture curable coating composition fails to form a cured coating having acceptable mechanical and cosmetic properties when cured at a relative humidity of 40% or lower, or 30% or lower, or 20% or lower, or 10% or lower and the low humidity cure coating on the substrate, cured under the respective relative humidity conditions, results in a cured coating having acceptable mechanical and cosmetic properties.

Additional objects, advantages and novel features will be apparent to those skilled in the art upon examination of the description that follows.

### DETAILED DESCRIPTION OF THE INVENTION

The low humidity moisture cure coatings, e.g., a low humidity cure zinc silicate coating, includes a slow evaporating volatile humectant in an amount sufficient to increase the cure rate of the coating and to provide acceptable mechanical and cosmetic properties for the cured coating under low humidity conditions. By “slow evaporating volatile humectant” is meant that the humectant evaporation rate is equal to or slower than the cure rate of the moisture curable binder with appropriately high humidity, i.e., at a relative humidity where the binder cures without the humectant, and that the humectant permits the moisture curable coating to cure below a specified relative humidity and results in a cured coating having acceptable mechanical and cosmetic properties when cured under such conditions. By “acceptable mechanical and cosmetic properties” is meant that the coating meets or exceeds minimum industry standards for drying for the particular intended application when tested according to standard drying test ASTM D1640 and D5895; has a pull-off strength of at least 4 MPa (580 psi) when tested according to ASTM D4541; for zinc silicate coatings, reaches a value of at least 4 within 24 hrs of curing at ambient temperature (i.e., about 20 to 25 C) for solvent rub test in accordance with ASTM D4752; for other moisture cure coatings, reaches a value of at least 4 within 24 hrs of curing at ambient temperature (i.e., about 20 to 25 C) for solvent rub test in accordance with ASTM D5402, as well as meeting minimum industry cosmetic standards for the particular intended application, e.g., minimum gloss level for certain topcoat applications.

In an embodiment of the invention, the low humidity cure zinc silicate coating is a two part coating made by mixing an alkyl silicate component (part A) with a zinc component (part B).

In an embodiment, part A is prepared as follows: an alkyl silicate hydrolysate intermediate is first formed by reacting an alkyl silicate with at least one water miscible alcohol functional solvent in the presence of an acid capable of reacting the alkyl silicate with the alcohol functional solvent(s) to form the hydrolysate intermediate. In one embodiment, the alkyl silicate is ethyl silicate. In an embodiment, the water miscible alcohol functional solvent can be chosen from ethylene glycol monobutyl ether (EB solvent), ethylene glycol monopropyl ether (EP solvent) or a combination thereof. In an embodiment, the acid is chosen from sulfuric of hydrochloric acid. In an embodiment, the hydrolysate reactants optionally include water to react with the alkyl silicate to improve applied film formation and cure speed of the final coating. The hydrolysate intermediate can then be mixed with the humectant, e.g., DMSO, to form part A of the coating.

Optional components of part A can include ethyl cellulose for sag control, along with suitable solvents to dissolve the ethyl cellulose; rheological additives, e.g., castor wax or organo clay (e.g., Bentone brand organo clay) for sag and settling control, if needed; extender mineral pigments, e.g., clay, feldspar or talc; and colored pigments, e.g., yellow or red iron oxide. In an embodiment, the solvents useful to dissolve the ethyl cellulose can be chosen from ethyl benzene, xylene and mixtures thereof.

In an embodiment where ethyl cellulose is included, the ethyl cellulose can be dissolved in the solvent(s) and a sufficient amount of hydrolysate intermediate can be mixed with the dissolved ethyl cellulose to form a good high speed dispenser vortex to disperse the other optional components listed above. The remaining hydrolysate intermediate can then be added after the optional components are dispersed. In an embodiment, a suitable let down solvent is then added and mixed with the other components prior to adding the humectant, as the final component of part A. In an embodiment, the let down solvent is a glycol ether or alcohol solvent capable of increasing the cure rate of the intermediate. In one embodiment, the glycol ether or alcohol solvent is propylene glycol monomethyl ether (PM solvent). In one embodiment, a small portion of the let down solvent can be added to the ethyl cellulose, along with the other solvent(s) used to dissolve the ethyl cellulose, and the remainder of the let down solvent can be added as described above.

In embodiments of the invention, the alkyl silicate, e.g., ethyl silicate, is present in an amount from about 5 to about 25, or about 7 to about 23, or about 9 to about 21 wt %; the water miscible alcohol functional solvent is present in an amount from about 1 to about 15, or about 1.5 to about 12, or about 2 to about 10 wt %; the water is present in an amount from 0 to about 3, or 0 to about 2.5, or 0 to about 2 wt %; based on the total weight of the zinc silicate coating. The acid can be present in a catalytic amount to promote reaction of the alkyl silicate, water and alcohol functional solvents present.

In embodiments of the invention, the ethyl cellulose is present in an amount from 0 to about 2, or 0 to about 1.5, or 0 to about 1 wt %; the solvent(s) to dissolve the ethyl cellulose is/are present in an amount from 0 to about 15, or 0 to about 12, or 0 to about 10 wt %; the rheological additives are present in an amount from 0 to about 3, or 0 to about 2.5, or 0 to about 2 wt %; the extender mineral pigments are present in an amount from 0 to about 30, or 0 to about 28, or 0 to about 26 wt %; the colored pigments are present in an amount from 0 to about 0.9, or 0 to about 0.7, or 0 to about 0.5 wt %; and the let down solvent is present in an amount from 0 to about 15, or 0 to about 12, or 0 to about 10 wt %; based on the total zinc silicate coating (i.e., both part A and part B). The humectant is present in an amount in the range of about 1 to about 8 wt %, or about 2 to about 7 wt %, or about 3 to about 6 wt %, or about 4 to about 5 wt %, based on the binder component (part A) with the humectant included.

In an embodiment, part B includes metallic zinc powder having 5-8 micron average particle size. In an embodiment, the zinc powder is present in an amount in the range of about 25 to about 75, or about 30 to about 70, or about 35 to about 68 wt %, based on the total zinc silicate coating.

In one embodiment of the invention, the intermediate hydrolysate is formed in the substantial absence of a slow evaporating volatile humectant. By “substantial absence” is meant that, if present, the humectant is in an amount insufficient to permit the coating to cure and have acceptable mechanical and cosmetic properties under the specified low relative humidity (RH) conditions, e.g., under 50% RH, or under 40% RH, or lower. In one embodiment, the intermediate hydrolysate is formed in the absence of the humectant.

It has been discovered that when DMSO is added to Part A in amounts greater than 8 wt %, based on Part A with humectant, mud cracking appearance and loss of adhesion has been observed when RH is >30% during cure. Also when more than 8% DMSO on Part A is used, applied primer films are left more porous as revealed by water readily soaking into the cured film (rather than beading) while surplus DMSO remains present and by a higher apparent volume solids when the surplus DMSO has evaporated compared to when 8% DMSO was used. It is believed that the surplus DMSO is yielding more voids in the primer film upon evaporation than is the case when 8% or less DMSO is used. Likewise, in the other moisture cure coatings evaluated, more than 8% DMSO on binder has been observed to cause blushing and loss of topcoat gloss.

In embodiments of the invention, the low humidity cure zinc silicate coating achieves good curing and final (cured) coating properties at humidity below 50% RH, or below 45% RH, or below 40% RH, or lower RH, e.g., 10% RH or lower.

### EXAMPLES

The following examples have been carried out to illustrate some embodiments of compositions and processes according to the invention.

Experiments for zinc silicate compositions were conducted using the formulation for Interzinc 22, QHA285 (from International Paint), as the part A component of the zinc silicate coating and Interzinc 22, QHA027 (from International Paint), as the part B component. To the part A was added varying amounts of DMSO and water, as shown in the tables below.

### Evaluation of DMSO and Water Addition and Humidity on Curing

The impact of the addition of DMSO and water on curing of the coating system (described above) at 25° C. and 20% RH was evaluated according to ASTM D4752 (for MEK rubs). It is also noted that the humidity rose to 33-35% RH when the chamber door was opened at the testing times shown. The results for different DMSO and water amounts, based on wt % of the part A, are shown in FIG. 1 below.

TABLE 1
Effect of DMSO and water at 20% RH

Time

| | 3 h | 5 h | 7 h | 22 h |
|---|---|---|---|---|
| Interzinc 22 (QHA285/ | 0 | 0+ | 1 | 3 |
| QHA027) | | | | |
| +4% DMSO | 3+ | 3+/4 | 3+/4 | 4/4+ |
| +4% water | 0+ | 2+ | 3 | 3/3+ |
| +4% DMSO + 4% water | 3 | 3+/4 | 4 | 4 |

A review of table 1 reveals that the addition of DMSO improves the curing of the zinc silicate coating system at 25° C. and 20% RH compared to the zinc silicate system without DMSO and with just water added.

The impact of the addition of DMSO and water on curing of the coating system (described above) at both 5° C. and 20% RH, and 25° C. and 10% RH, was evaluated according to ASTM D4752. The chamber conditions were temporarily changed to 25° C. and 0% RH before opening the door at evaluation times to avoid condensation on panels that could impact the results. Higher humidity was also introduced to determine if samples that were slow to cure at the low RH (within the indicated time) could later be cured with more humidity. The results for different DMSO and water amounts, based on wt % of the part A, are shown in FIGS. 2 and 3 below.

TABLE 2
Effect of DMSO and water at 5° C. and 20% RH

| | Time | | |
|---|---|---|---|
| | | | +15.5 h at 25° C./50% |
| | 19 h | 48 h | RH |
| Interzinc 22 (QHA285/QHA027) | 0 | 2 | 5 |
| +4% water | 1 | 4 | 5 |
| +1% DMSO + 4% water | 2+ | 4 | 5 |
| +4% DMSO | 3 | 4+ | 5 |
| +4% DMSO + 4% water | 3+ | 5 | 5 |
| +3% DMSO + 1% water | 2+ | 3 | 3+/4 |
| +3% DMSO + 3% water | 3 | 3+ | 3+/4 |

TABLE 3
Effect of DMSO and water at 25° C. and 10% RH

| | Time | | |
|---|---|---|---|
| | 6 h | 19 h | +5 h at 24° C./44% RH |
| Interzinc 22 (QHA285/QHA027) | 0 | 1 | 3 |
| +1% DMSO | 0+ | 2 | 4 |
| +1% DMSO + 1% water | 1 | 2+ | 4+/5 |
| +1% DMSO + 4% water | 2 | 3/3+ | 5 |
| +4% DMSO | 2+ | 3+ | 5 |
| +4% DMSO + 4% water | 2+/3 | 4+ | 5 |

A review of tables 2 and 3 reveals that DMSO in sufficient amounts improves curing of the coating and that the amount of water in combination with the DMSO does not have a significant effect on the curing. Also, the coating generally continued to cure after the RH was increased following the low RH testing.

Evaluations of hydrid organic alkoxysilane (polysiloxane) and isocyanate moisture cure compositions in accordance with the invention were also conducted.

### Hybrid Organic Alkoxysilane (Polysiloxane) Example

Interfine 1080 (from International Paint LLC) single pack moisture cure acrylic polysiloxane finish coat was applied as is at 2-3 mils dft. Additional finish coats were applied with added DMSO, as follows: coatings applied with 4% and 10% DMSO in Interfine 1080, respectively. All panels were cured side-by-side on benchtop at 20° C. and 30% RH. The results for different DMSO amounts, based on wt % of the Interfine 1080, are shown in FIG. 4 below.

TABLE 4
Effect of DMSO at 20° C. and 30% RH

| Coating | Touch Dry | Surface Dry | Tack Free | Hard Dry |
|---|---|---|---|---|
| Interfine 1080 | 3 h | >4 h | — | — |
| +4% DMSO | 1.5 h | 2.25 h | 2 h | 4 h |
| +10% DMSO | 1 h | 1.75 h | 2.25 h | 3 h* |

*Blushed when hard dry causing low gloss

A review of table 4 reveals that DMSO accelerates cure of Interfine 1080 under these conditions, with 10% DMSO speeding cure more than 4% DMSO. However, 10% DMSO proved too much, causing loss of gloss.

### Isocyanate Moisture Cure Example

An HDI based polyisocyanate high solids clearcoat of Tolonate HDT-LV2 with 0.1% dibutyltindilaurate catalyst was applied at 2-3 mils dft. Similar coatings were applied with 4% and 10% DMSO on Tolonate HDT-LV2, respectively. All panels were cured side-by-side on benchtop at 20° C. and 30% RH. The results for different DMSO amounts, based on wt % of the Tolonate HDT-LV2, are shown in FIG. 5 below.

TABLE 5
Effect of DMSO at 20° C. and 30% RH

| Coating | Touch Dry | Surface Dry | Tack Free | Hard Dry |
|---|---|---|---|---|
| HDI Clearcoat | 5.5 h | 7 h | >9 h | — |
| +4% DMSO | 4 h | 4.5 h | 7 h | 9 h |
| +8% DMSO | 3.5 h | 4 h | 6 h | 9 h |
| +10% DMSO | 3 h | 3.5 h | 5 h | 7.5 h* |

*Some gloss reduction noticed when hard dry

A review of table 5 reveals that DMSO accelerates cure of the moisture cure isocyanate system under these conditions, and higher DMSO levels increasing cure speed more than lower levels. However, too much DMSO can cause loss of gloss.

1. A low humidity cure moisture curable coating composition comprising:
a) a moisture cure binder component which comprises:
i) a moisture curable binder material, and
ii) at least one an organic solvent; and
b) a humectant component which comprises a slow evaporating volatile humectant;
wherein the humectant is present in an amount sufficient to increase the cure rate of the coating at a relative humidity of 50% or lower and to provide a cured coating having acceptable mechanical and cosmetic properties when cured at a relative humidity of 50% or lower.

2. The coating composition according to claim 1, wherein the moisture curable binder material is chosen from an alkyl silicate based material, a hybrid organic alkoxysilane based material, a polyisocyanate based material which yields polyurea via moisture curing, a polyketamine based material which yields free amines via moisture curing for reaction with epoxies or isocyanates, and polyurethane compositions of isocyanate and polyol where the isocyanate is in sufficient excess to the polyol that moisture cure of isocyanate (yielding polyurea) is required to properly cure the coating.

3. The coating composition of claim 1 wherein the moisture curable coating composition is a two part zinc silicate coating composition which further comprises a zinc component in addition to the moisture curable binder and humectant components; wherein the moisture curable binder material is an alkyl silicate hydrolysate intermediate, wherein the hydrolysate intermediate is the reaction product of an alkyl silicate and at least one water miscible alcohol functional solvent; wherein the organic solvent is a glycol ether or alcohol solvent, wherein the glycol ether or alcohol solvent is a type and is present in an amount that increases the cure rate of the intermediate; and wherein the zinc component is chosen from zinc powder, zinc oxide or mixtures thereof.

4. The coating composition of claim 1 wherein the humectant is dimethyl sulfoxide (DMSO).

5. The coating composition of claim 1 wherein the humectant is present in an amount sufficient to increase the cure rate of the coating and to provide a cured coating having acceptable mechanical and cosmetic properties at a relative humidity of 30% or lower.

6. The coating composition according to claim 1 wherein the coating composition contains water in an amount from 0 to about 4 wt %, based on the coating composition.

7. The coating composition according to claim 1 wherein the humectant is present in an amount from about 1 to about 8 wt %, based on the combination of the binder component and humectant component.

8. A method for curing a moisture curable coating composition under low humidity conditions, said method comprising:
a) providing a high humidity moisture curable coating composition that is capable of curing under sufficiently high relative humidity, but which fails to form a cured coating having acceptable mechanical and cosmetic properties at a relative humidity of 50 wt % or lower;
b) adding a slow evaporating volatile humectant to the high humidity moisture curable coating, in an amount sufficient to increase the cure rate of the coating at a relative humidity of 50% or lower and sufficient to provide a cured coating having acceptable mechanical and cosmetic properties when cured under such conditions;
c) mixing the resulting composition containing the humectant, to provide a low humidity cure coating composition;
d) coating the low humidity cure coating composition on a substrate; and
e) curing the coating on the substrate under conditions where the relative humidity is 50% or lower.

9. The method according to claim 8, wherein the high humidity moisture curable coating composition that is capable of curing under sufficiently high relative humidity, but which fails to form a cured coating having acceptable mechanical and cosmetic properties at a relative humidity of 30 wt % or lower.

10. The method according to claim 8 wherein the humectant is DMSO.

11. The method according to claim 8 wherein the moisture curable coating composition is a two part zinc silicate coating comprising a binder component part A and a zinc component part B, wherein the binder component part A is the high humidity coating composition, and wherein the method further comprises adding a zinc component part B to the low humidity cure coating of step c).

12. The method according to claim 11, wherein the humectant is present in an amount from about 1 to about 8 wt %, based on the low humidity cure coating composition of step c).

13. The coating composition of claim 2 wherein the moisture curable coating composition is a two part zinc silicate coating composition which further comprises a zinc component in addition to the moisture curable binder and humectant components; wherein the moisture curable binder material is an alkyl silicate hydrolysate intermediate, wherein the hydrolysate intermediate is the reaction product of an alkyl silicate and at least one water miscible alcohol functional solvent; wherein the organic solvent is a glycol ether or alcohol solvent, wherein the glycol ether or alcohol solvent is a type and is present in an amount that increases the cure rate of the intermediate; and wherein the zinc component is chosen from zinc powder, zinc oxide or mixtures thereof.

14. The method according to claim 9 wherein the humectant is DMSO.
